(19) United States
(12) Patent Application Publication
(10) Pub. No.: US 2006/0086419 A1
(43) Pub. Date: Apr. 27, 2006

(54) Mobile high-speed biomass processor for Chunkwood with integral Chunkwood baler

(76) Inventors: Warren Ahlson Aikins, Rainier, OR (US); James Edward Aikins, Modesto, CA (US)

Correspondence Address: Warren A. Aikins, PO Box 748, Rainier, OR, 97048, US

(21) Appl. No.: 11/187,127

(22) Filed: Jul. 22, 2005

Related U.S. Application Data
(60) Provisional application No. 60/590,589, filed on Jul. 23, 2004.

(51) Int. Cl. B27C 1/00

(52) U.S. Cl. 144/162.1

(57) ABSTRACT

A mobile wood/log processor used for the production and baling of Chunkwood to be used as hog fuel for the production of electrical power. The machine uses a plurality of guillotine type shear blades 27 to produce the Chunkwood. The Chunkwood is then compressed and fed into the baler assembly 34. The completed bale is then discharged to the ground for pickup and transport to the power plant.

### CROSS-REFERENCE TO RELATED APPLICATIONS

This application claims the benefit of provisional patent application Ser. No. 60/590,589, filed 2004 Jul. 23 by the present inventors

### BACKGROUND OF THE INVENTION

1. Field of Invention

This invention relates to the production of biomass fuel using short chunks of wood as the fuel.

2. Prior Art

This invention relates to improvements in the AUTOMATIC WHOLE AND MULTIPLE TREE FIREWOOD/HOG FUEL PROCESSOR Described in U.S. Pat. No. 4,805,676. Issued Feb. 21, 1989 to one of the present inventors, Warren A. Aikins.

The machine described in said patent was designed to produce either firewood or shorter chunks of wood (Chunkwood) to be used as hog fuel for the commercial production of electrical power.

### BACKGROUND OF INVENTION—OBJECTS AND ADVANTAGES

After building a prototype machine as described in U.S. Pat. No. 4,805,676, and producing some Chunkwood, it was found that these chunks lost moisture content at an accelerated rate compared to the longer length firewood pieces. Also, a study was presented at a meeting of the International Energy Agency held Dec. 6-7, 1988 at the University of Sweden in Uppsala, Sweden showing the following advantages of Chunkwood:
(a) Requires less energy to produce than chips.
(b) Bulk density is 13-20 percent higher than chips.
(c) Dries faster than chips when stored under ambient air drying conditions.
(d) More complete combustion and less particulate emission.

The foregoing statements make Chunkwood the ultimate wood particle size for maximum heat recovery. Renewable energy resources are very much in demand. Sources of wood for the production of Chunkwood are plentiful. Some of the sources include logging slash, forest thinnings, burned over forest lands, diseased forests, etc. Biomass energy can be produced in volume at competitive costs with the “Mobile High-Speed Biomass Processor for Chunkwood with Integral Chunkwood Baler”.

Another important use for Chunkwood is for the construction of low-volume, temporary roads, such as logging roads. The Chunkwood is used in place of conventional road building materials, such as, pit-run gravel and crushed aggregate. In many cases, these materials are not always abundantly available within an economical transport distance. Chunkwood effectively stabilizes unpaved roadways, and its light weight is a major advantage. This use for Chunkwood was also presented at the meeting of the IEA in Uppsala, Sweden by the USDA Forest Service.

The invention will be better understood and additional features and advantages will become apparent from the preferred embodiment illustrated in the accompanying drawings. Various changes may be made in the details of construction and arrangement of parts and certain features may be used without others.

### SUMMARY

In accordance with the present invention a machine is designed to produce Chunkwood fuel for commercial use in the production of electrical power.

### DRAWINGS—Figures

FIG. 1 is an isometric view of a machine embodying the invention

FIG. 2 is a side elevation view of the multiple shear blade chunker carriage.

FIG. 3 is a side elevation view of the Chunkwood baler assembly

FIG. 4 is a side elevation of the Chunkwood tunnel in the clamped and extended position

FIG. 5 is a side elevation of the Chunkwood Baler tunnel in the rotated dump position

### DESCRIPTION OF THE INVENTION

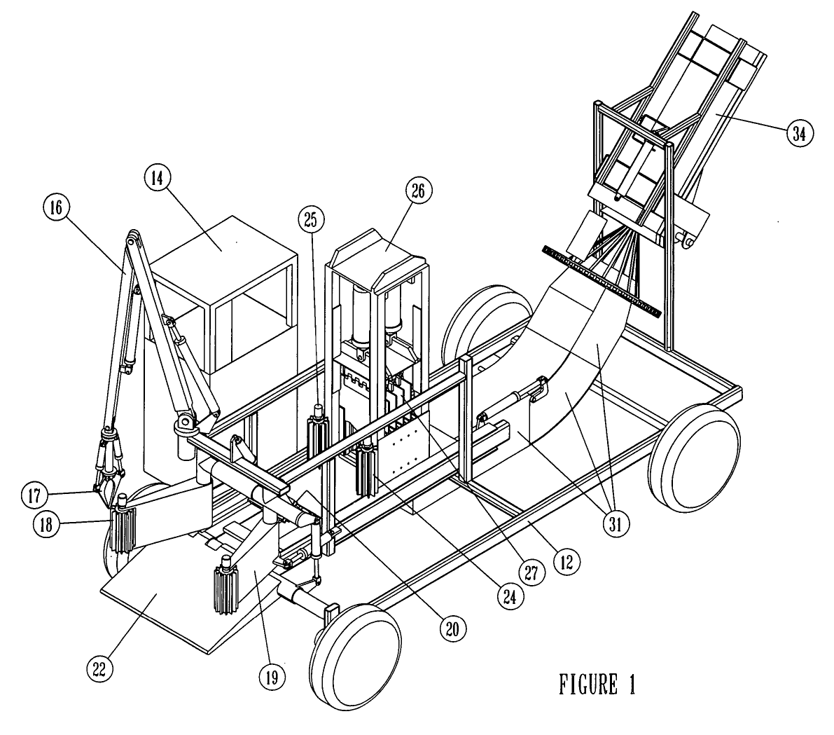

As seen in FIG. 1 the mobile main frame 12 is composed of the following main components.

22 Adjustable infeed to act as a ramp to guide logs and slash fed by knuckle boom 16 and grapple 17 (shear on grapple optional) into the throat of the machine at the proper elevation.

18 & 19 Hydraulically powered squeeze infeed rolls to help feed and compress input material.

20 Top hydraulically powered squeeze roll to compress input material before entering 26 the Multiple shear blade chunker carriage.

24 & 25 Hydraulically powered side rolls used to guide material into chunker carriage.

26 Multiple shear blade carriage

27 Multiple shear blades for cutting the infeed material into Chunkwood

14 Operators cab

31 Chunkwood compression assembly

34 Chunkwood baler apparatus

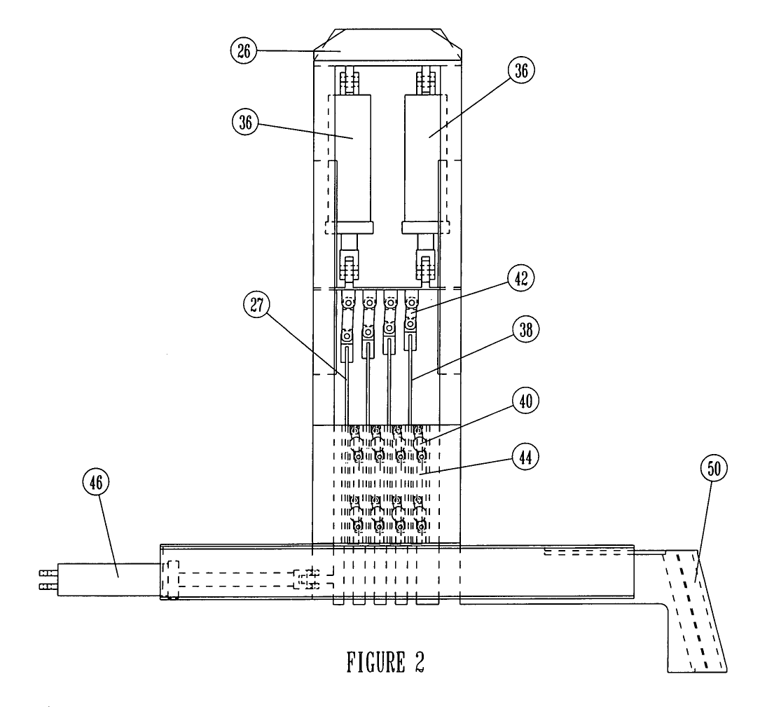

FIG. 2 shows the details of the Chunkwood carriage assembly.

Shear blades 27 are shown mounted in floating blade guides 44 to accommodate blade movement caused by the displacement of the wood while shearing. Shear cylinders or cylinder 36 are shown mounted in carriage frame assembly 26. Hydraulic cylinder 46 has two major functions;

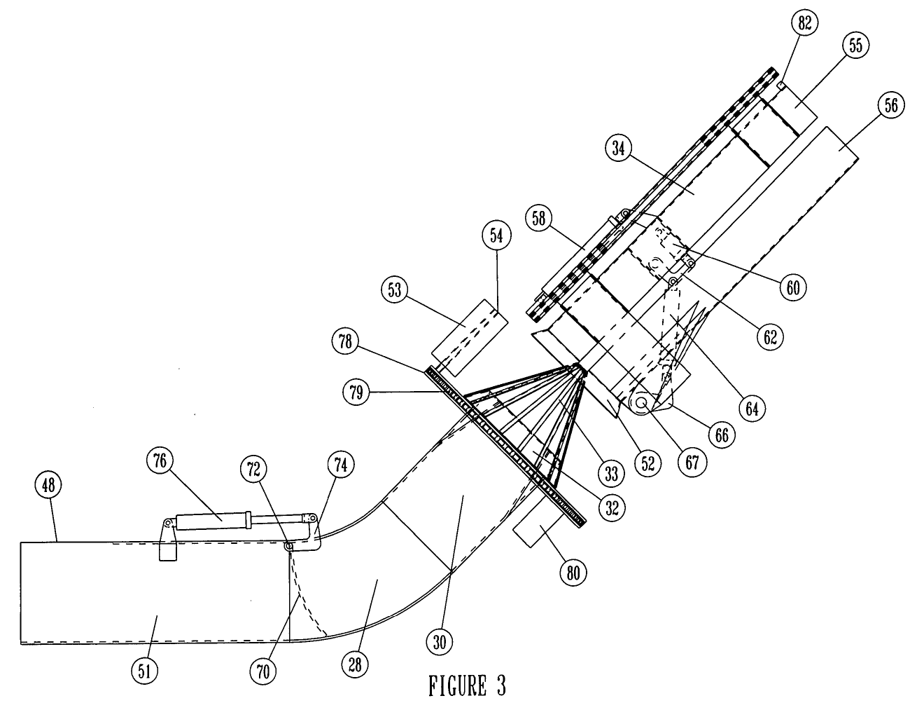

One, to move the carriage forward and at the same time compress the chunks just sheared in the previous cycle in the compression chamber 51, shown in FIG. 3 with pusher plate 50 which is an integral part of the shear blade carriage, and two, to return the shear blade carriage to the starting position.

Operation of Chunkwood Processor

The knuckle boom grapple 17 feeds logs, slash, brush etc. into the throat of the machine to the feed rolls 18, 19, 20, 24 and 25 as seen in FIG. 1. The operation and function of these components are defined in U.S. Pat. No. 4,805,676 issued to Warren Aikins, Feb. 21, 1989. The patent shows only one shear blade in the shear blade carriage 26. The present patent has a plurality of shear blades to increase the Chunkwood production. The wood chunks produced will be fed to the Chunkwood baler assembly.

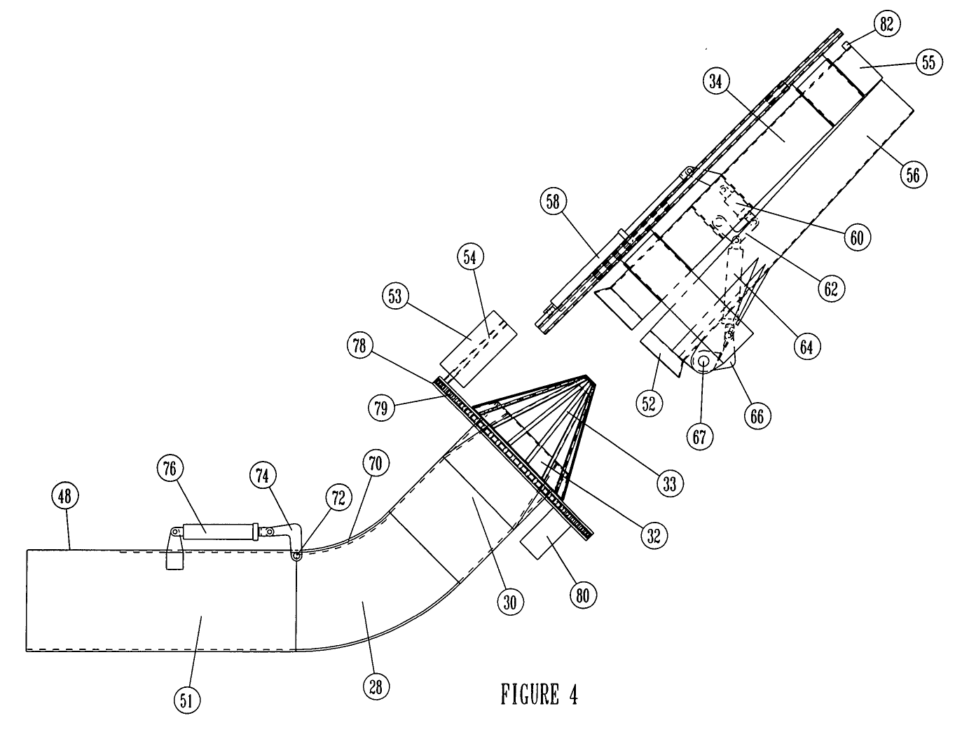

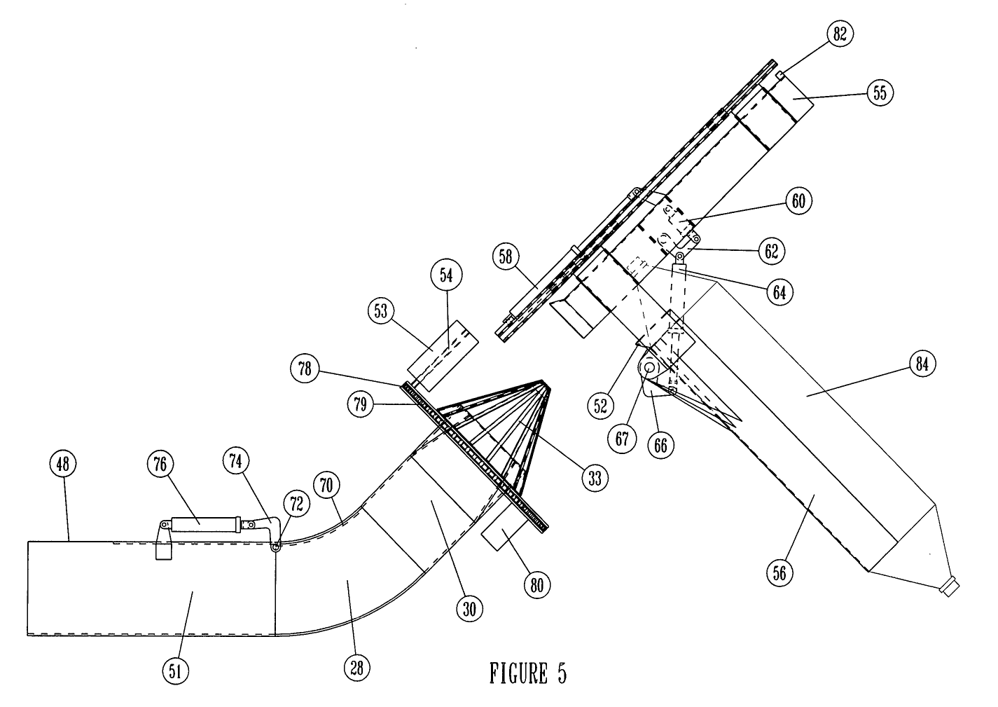

FIGS. 3, 4 and 5 show details of the baler assembly

Operation of Chunkwood Baler

Chunks produced by the Multi-shear blades 27 are pushed into opening 48 of the compression chamber 51 by the wood/logs in the processor when the carriage 26 is moved toward the infeed by carriage by cylinder 46 during the processing cycle. When the carriage moves toward the outfeed during the processing cycle, the pusher plate assembly 50, which is an integral part of the carriage assembly 26, pushes the chunks in the compression chamber 51 into the chunkwood pressure control plate 70 which is connected to pivot shaft 72. Lever arm 74 is connected to pivot shaft 72. Chunkwood pressure control cylinder 76 is connected to lever arm 74. The pressure control plate 70 remains in the closed position until the desired compression pressure on the chunkwood is reached. The cylinder 76 then stars to retract allowing the pressure plate 70 to start opening. As more chunks are added during each processing cycle, the pressure control plate 70 is pushed further open until the 45 degree transition 28 is full of compressed chunks. The chunks are then forced into the square to round transition 30. The square to round transition 30 reduces the area approximately 22.5 percent, increasing the compression force on the chunks. The tapered cone 32 is attached to transition 30. Spring steel flat bars 33 are bolted to tapered cone 32 forming a cone shape. Compressed chunks force the spring steel flat bars open to the approximate diameter of the transition 30. Bio-degradable mesh roll 53 is wrapped around the spring steel flat bars 33 to encase the compressed chunks. The mesh roll 53 is mounted on shaft 54 which is connected to rotating ring assembly 78 which rotates on stationary ring assembly 79. The rotational speed of the rotating ring assembly 78 is powered and controlled by mesh roll drive hydraulic motor 80. During each compression cycle, the amount of rotation of the mesh roll 53 is set to give an approximate 30 percent overlap of mesh. As the encased spiral wrapped chunks of wood moves toward the outfeed, they are fed into the bale tunnel assembly 34. The infeed guide cone 52 directs the Chunkwood bale into the tunnel assembly 34. The mesh wrapped bale progresses through the bale tunnel until it actuates sensor 82. The sensor actuates the clamp cylinder 60, which is connected to pivot arm 62, causing bottom half of tunnel cover 56 to raise, clamping the bale against the top half 55 of the bale tunnel. After the bale is clamped, tunnel cylinder 58 is actuated, moving the whole bale tunnel assembly toward the outfeed. When tunnel cylinder 58 is actuated, the mesh roll hydraulic drive motor 80 increases speed so the mesh has an overlap of approximately 80 percent of the width of the mesh. When the bale tunnel is fully extended, two nylon tie straps are manually installed and the mesh is manually cut in half between the straps. After the mesh is cut, the clamp cylinder 60 is actuated and releases the bale The dump cylinder 64 is connected to the bale tunnel lower half pivot arm 66 which is connected to pivot shaft 67. The pivot shaft 67 is connected to the tunnel lower half 56 when the dump cylinder 64 is actuated, it rotates the lower tunnel half 56 rotates 90 degrees in the clockwise direction. The completed sausage shaped bale 84 slides to the ground. The lower half then returns to the operating position and the tunnel cylinder 58 returns the tunnel assembly 34 to the operating position. This completes the baling cycle.

We claim:

1. A self-contained mobile wood/log processor comprising an elongated main frame with an input and output end, a carriage assembly containing a plurality of guillotine like shear blades to process logs and other wood stems into short chunks of wood which are fed into a machine which compresses and bales the short chunks of wood.

2. A manually operated hydraulic log grapple to be mounted on the input end of the main frame as defined in claim 1 to feed the wood/logs to the input throat of the machine for processing.

3. A machine as defined in claim 1 having a plurality of shear blades mounted in polymer sprung floating blade guides, allowing longitudinal movement of each individual blade caused by the shear blade thickness as it penetrates and displaces the wood.

4. The shear blades as defined in claim 3 are positioned in a sequentially increasing, rise and run equal vertical distance above the bottom edge of the blade closest to the input to allow the material being sheared to move toward the output caused by the thickness of each blade as it penetrates and displaces the wood.

5. A machine as defined in claim 1 including a pusher plate assembly mounted on the outfeed of the shear blade carriage.

6. A machine as described in claim 5 having means to force the short chunks of wood produced by the plurality of shear blades into a compression chamber.

7. A machine as defined in claim 6 having a moveable pressure control plate to control the desired compressive pressure on the wood chunks.

8. A machine as defined in claim 7 having a plurality of spring loaded flat bars formed in a cone shape to be forced open to form a cylindrical shape as the compressed chunks exit the compression chamber.

9. A machine as defined in claim 8 using the flat bars as a support for wrapping a flat open mesh material around the encased compressed wood chunks.

10. A machine as defined in claim 9 to include means for controlling the overlap of the flat mesh material as the compressed chunks progress toward the output during the processing cycle.

11. In a wood/log processing machine for chunkwood, a frame at an angular position and a cylindrical tunnel assembly mounted on and parallel to the frame.

12. The tunnel of claim 11 is composed of two main elements, a top half and a lower half.

13. A machine as defined in claim 11 is located to receive and support the mesh-wrapped chunks exiting the compression chamber.

14. A machine as defined in claim 11 with means to move the tunnel assembly parallel to the frame.

15. A machine as defined in claim 11 to include means to clamp the cylinder shaped, spirally wrapped chunks when they reach the outfeed end of the tunnel during the processing cycle.

16. The lower half of the tunnel as defined in claim 12 to include a horizontal hinge located at the located at the input end and tangent to the radius at the lowest point.

17. A machine as defined in claim 16 to include means to rotate the lower half of the tunnel, at the hinge, clockwise to allow the finished chunkwood bale to slide, by gravity to the ground.
